(19) United States
(12) Patent Application Publication
(10) Pub. No.: US 2026/0288064 A1
(43) Pub. Date: Sep. 24, 2026

(54) TIMEPIECE MOVE PART AND TIMEPIECE

(71) Applicant: SEIKO WATCH KABUSHIKI KAISHA (trading as SEIKO WATCH CORPORATION), Tokyo (JP)

(72) Inventors: Natsuki MATSUMOTO, Tokyo (JP); Shotaro KAMIYAMA, Tokyo (JP); Takuya MURAZUMI, Tokyo (JP); Jun TSUNEYOSHI, Chiba (JP)

(21) Appl. No.: 19/552,109

(22) Filed: Feb. 27, 2026

(30) Foreign Application Priority Data
Mar. 24, 2025 (JP) 2025-048189
Aug. 6, 2025 (JP) 2025-131873

(51) Int. Cl. G04B 13/02; G04B 17/32

(52) U.S. Cl. CPC G04B 13/02; G04B 17/32

(57) ABSTRACT

An object of the present invention is to provide a timepiece move part. A timepiece move part according to the present invention contains a Ni—Cr—Al alloy having a composition of 30 mass % to 40 mass % of Cr, 3 mass % to 5 mass % of Al, the balance being Ni and unavoidable impurities, and including an αCr phase, a γ phase which is a solid solution of NiCr, and a γ′ phase containing Ni₃Al. It is preferable that the Ni—Cr—Al alloy further contains 0.8 mass % or less of one or two or more elements selected from B, Mg, Ti, and Si. It is preferable that the Ni—Cr—Al alloy has hardness of 650 HV or more. It is preferable that the Ni—Cr—Al alloy has a crystallite size of 152 Å to 213 Å or less, calculated from a 400-diffraction peak obtained by X-ray diffraction for the γ phase and the γ′ phase.

### RELATED APPLICATIONS

This application claims priority to Japanese Patent application No. JP2025-048189, filed on Mar. 24, 2025, and Japanese Patent application No. JP2025-131873, filed on Aug. 6, 2025, the entire content of which is incorporated herein by reference.

### BACKGROUND OF THE INVENTION

### 1. Field of the Invention

The present invention relates to a timepiece move part and a timepiece.

### 2. Description of Related Art

A general part of a wristwatch is made of high-carbon steel, brass, or stainless steel. Among the part of the wristwatch, particularly, a part that is affected by magnetism and affects the accuracy of the timepiece is a part around an escapement and a speed governor, which is made of high-carbon steel.

In recent years, the timepiece part has become increasingly non-magnetic, and the following materials are being used for a hairspring, a body of pallet fork, and an escape wheel.
Hairspring: paramagnetic material such as Si, paramagnetic material such as Nb—Zr alloy, and diamagnetic material such as carbon fiber
Body of pallet fork and escape wheel: amorphous material such as Ni—P, paramagnetic material such as Si

However, for a part with shaft among the timepiece part, high-carbon steel (a ferromagnetic material) is still used in view of impact resistance and abrasion resistance.

On the other hand, there has been known precipitation-hardened Ni—Cr—Al alloy as the paramagnetic material, but only application of the alloy to an exterior of a timepiece has been studied.

For example, JPS55-021096B below discloses a Ni—Cr—Al alloy containing 30 wt % to 45 wt % of Cr and 2.5 wt % to 5 wt % of Al, and the alloy is used for a timepiece.

JPS59-027378B below discloses a Ni—Cr—Al alloy containing 35 wt % to 43 wt % of Cr and 0.01 wt % to 5 wt % of Al, with a γ′ phase precipitated, and the alloy is used in a production method for a timepiece.

JP4567826B below discloses an alloy containing 35 wt % to 43 wt % of Cr, 0.1 wt % to 10 wt % of Al, and a specific amount of an additive element such as Si, C, Mg, Mn, Ti, and B, and the alloy is used for a pressure forming mold.

JP3769606B below describes an alloy containing, by weight, 55% to 58% Ni, 38% to 42% Cr, 2% to 4% Al, and a small amount of B added. The alloy has high strength suitable for applications such as a tool and has improved hot workability.

JP2009-179849A below discloses a non-magnetic high-strength alloy containing specific amounts of C, Si, Mn, Cr, and Al, with the balance being Ni. The alloy is known as an alloy for an engine exhaust system and a gas turbine.

Various precipitation-hardened Ni—Cr—Al alloys have been proposed in the related art, as described in JPS55-021096B, JPS59-027378B, JP4567826B, JP3769606B and JP2009-179849A, but no examples of application thereof to a timepiece move part have been known.

When the timepiece move part is magnetized by an external magnetic field, a stop or a rate shift occurs, which adversely affects the accuracy of the timepiece. Therefore, when the timepiece part is made of a ferromagnetic material, there is an influence both during exposure to an external magnetic field and after leaving the magnetic field, and there is a concern that a stop or a rate shift may occur. However, in order to ensure abrasion resistance and impact resistance, high-carbon steel is still used for a shaft part of a timepiece.

Currently, the following three characteristics are considered to be important for the shaft part of the timepiece, but no materials in the related art have been found that satisfy the three characteristics at a high level.
(1) Non-ferromagnetic material. That is, the material is not affected by a magnetic field or is less affected by a magnetic field than a ferromagnetic material.
(2) High abrasion resistance (high hardness).
(3) Excellent impact resistance (high tensile strength and high impact absorption energy).

Therefore, the present application has been made as a result of research on a technique of applying to a timepiece move part, a Ni—Cr—Al alloy that is hardened through precipitation of a γ′ phase (Ni₃Al) as a paramagnetic material.

### SUMMARY OF THE INVENTION

It is an aspect of the present application to provide a timepiece move part that is unlikely to be affected by a magnetic field, has high hardness, and is excellent in impact resistance, and a timepiece including the timepiece move part.
(1) A timepiece move part according to the present application includes: a Ni—Cr—Al alloy containing 30 mass % to 40 mass % of Cr and 3 mass % to 5 mass % of Al, including an αCr phase, a γ phase which is a solid solution of NiCr, and a γ′ phase containing Ni₃Al.
(2) In the timepiece move part according to the present application, it is preferable that the Ni—Cr—Al alloy further contains 0.8 mass % or less of one or two or more elements selected from B, Mg, Ti, and Si.
(3) In the timepiece move part according to the present application, it is preferable that the Ni—Cr—Al alloy has hardness of 650 HV or more.
(4) In the timepiece move part according to the present application, it is preferable that the Ni—Cr—Al alloy has a crystallite size of 152 Å to 213 Å, calculated from a 400-diffraction peak obtained by X-ray diffraction for the γ phase and the γ′ phase.
(5) In the timepiece move part according to the present application, it is preferable that the Ni—Cr—Al alloy has impact absorption energy of 2.1 J/cm² or more.
(6) In the timepiece move part according to the present application, it is preferable that the Ni—Cr—Al alloy has tensile strength of 1980 MPa or more.
(7) In the timepiece move part according to the present application, it is preferable that the timepiece move part includes a surface-hardened layer in a range from an outermost surface to a depth of 15 μm.
(8) In the timepiece move part according to the present application, it is preferable that the Ni—Cr—Al alloy has a relative magnetic permeability of less than 1.01.
(9) In the timepiece move part according to the present application, it is preferable that the timepiece move part is any one or two or more of a center pinion, a center wheel, a third pinion, a third wheel, a second pinion, a second wheel, a center second pinion, a center second wheel, an intermediate escape pinion, an intermediate escape wheel, an escape pinion, an escape wheel, a body of pallet fork, a pallet staff, a balance staff, a balance wheel, a collet, a double roller, a part fixation screw, a regulator, a regulator pointer, and a fine adjustment lever.
(10) A timepiece according to the present application includes: the timepiece move part according to any one of (1) to (8).
(11) A timepiece according to the present application includes: the timepiece move part according to (9).

The timepiece move part according to the present application contains a non-magnetic Ni—Cr—Al alloy having a composition of 30 mass % to 40 mass % of Cr, 3 mass % to 5 mass % of Al, the balance being Ni and unavoidable impurities, and including an αCr phase, a γ phase which is a solid solution of NiCr, and a γ′ phase containing Ni₃Al. Therefore, a timepiece move part having excellent abrasion resistance and impact resistance while having a feature of being less affected by a magnetic field can be provided.

When the crystallite size calculated by an FP method from the 400-diffraction peak obtained by X-ray diffraction for the γ phase and the γ′ phase is 152 Å to 213 Å, a timepiece move part which is insensitive to aging time, exhibits a gradual decrease in hardness during overaging, and is excellent in mass productivity can be provided.

### BRIEF DESCRIPTION OF THE DRAWINGS

FIG. 1 is an external view illustrating the first embodiment of a timepiece according to the present invention.

FIG. 2 is a plan view of a timepiece movement provided in the timepiece according to the first embodiment.

FIG. 3 is a plan view illustrating an example of a balance with hairspring provided in the timepiece movement illustrated in FIG. 2.

FIG. 4 is a sectional view of the balance with hairspring.

FIG. 5 is a graph illustrating an example of an X-ray diffraction peak of a Ni-38 mass % Cr-4 mass % Al alloy in a solution-treated state.

FIG. 6 is a graph illustrating an example of an X-ray diffraction peak of the alloy after aging treatment.

FIG. 7 is a diagram illustrating an example of a state diagram of a ternary alloy having a composition of 30 mass % to 40 mass % of Cr, 3 mass % to 5 mass % of Al, and the balance being Ni.

FIG. 8(A) is a side view illustrating an example of an escape wheel and an escape pinion, FIG. 8(B) is a partial enlarged view, and FIG. 8(C) is a partial cross-sectional view.

FIG. 9 is a side view illustrating an example of a pallet staff and a body of pallet fork.

FIG. 10 is a side view illustrating an example of a balance staff.

FIG. 11 is a graph illustrating a VSM measurement result of a Ni-38 mass % Cr-4 mass % Al alloy at room temperature after aging.

FIG. 12 is a graph illustrating a relationship between a crystallite size and impact absorption energy of a γ′ (Ni₃Al) precipitation-hardened Ni—Cr—Al alloy, with a comparison to the value of impact absorption energy of PbS100C (high-carbon steel).

FIG. 13 is a graph illustrating a relationship between a crystallite size and impact absorption energy of the Ni-38 mass % Cr-4 mass % Al alloy subjected to various aging conditions, with a comparison to the value of impact absorption energy of PbS100C.

FIG. 14 is a graph illustrating a relationship between hardness and a crystallite size calculated from a 400-diffraction peak by an FP method.

FIG. 15 is a graph illustrating a relationship between an aging time and the hardness when the Ni-38 mass % Cr-4 mass % Al alloy is aged at 590° C.

FIG. 16 is a graph illustrating a relationship between the aging time and the hardness when the Ni-38 mass % Cr-4 mass % Al alloy is aged at 554° C. to 629° C.

FIG. 17 is a graph illustrating an XRD spectrum (CuKα) of a solution-treated material.

FIG. 18 is a graph illustrating an XRD spectrum (CuKα) of a material aged at 590° C. for 24 hours.

### DETAILED DESCRIPTION OF THE PREFERRED EMBODIMENTS

Hereinafter, embodiments of the present invention will be described with reference to the drawings. In the present embodiment, a mechanical timepiece will be described as an example of a timepiece. In each drawing, the scale of each part is appropriately changed such that each part has a visible size.

### Configuration of Timepiece According to First Embodiment

In general, a machine body including a driving portion of the timepiece is referred to as a “movement”. A state in which a dial and hands are attached to the movement and the obtained product is put into a timepiece case to form a finished product is referred to as a “complete” timepiece. Of both sides of a main plate forming a substrate of the timepiece, a side where a glass of the timepiece case is provided (a side where the dial is provided) is referred to as a “back side” of the movement. Of both sides of the main plate, a side where a case back of the timepiece case is provided (a side opposite to the dial) is referred to as a “front side” of the movement.

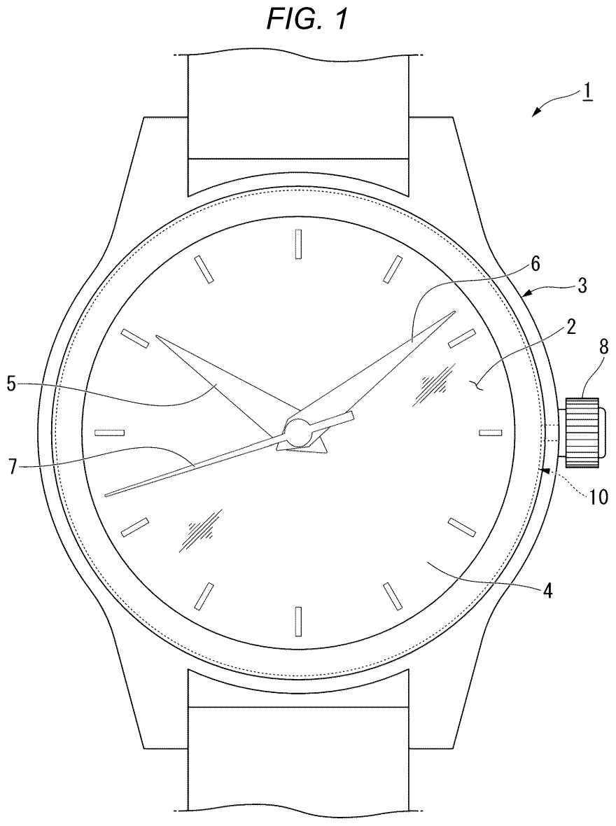

As illustrated in FIG. 1, a complete timepiece 1 of the first embodiment includes a movement (a timepiece movement) 10, a dial 4 having a scale (hour markings) indicating at least information on the hour, and hands including an hour hand 5 indicating the hours, a minute hand 6 indicating the minutes, and a second hand 7 indicating the seconds, all housed within a timepiece case 3 including a case back (not illustrated) and a glass 2.

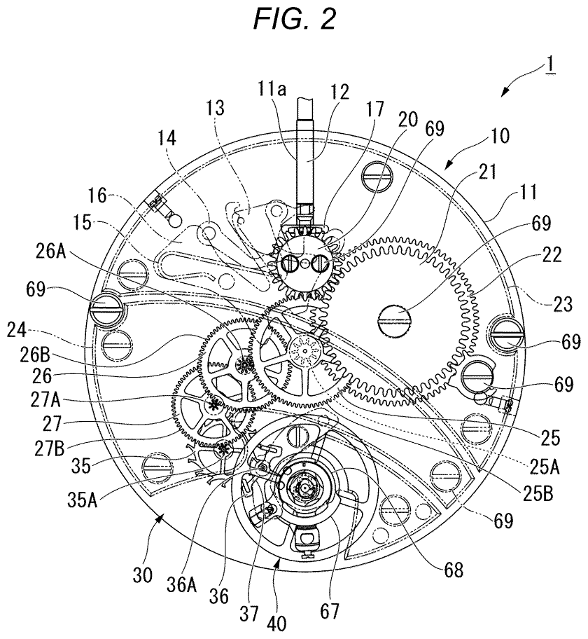

As illustrated in FIG. 2, the movement 10 includes a main plate 11 forming a substrate. In FIG. 2, in order to make the drawing easy to see, illustration of a part of parts forming the movement is omitted.

A winding stem guide hole 11a is formed in the main plate 11. A winding stem 12 coupled to a crown 8 illustrated in FIG. 1 is rotatably incorporated in the winding stem guide hole 11a. The position of the winding stem 12 in an axial direction is determined by a switching device including a setting lever 13, a yoke 14, a yoke spring 15 and a setting lever jumper 16. A winding pinion 17 is rotatably provided on a guide shaft portion of the winding stem 12.

When the winding stem 12 is rotated in the above configuration, the winding pinion 17 rotates via rotation of a clutch wheel (not illustrated). When the winding pinion 17 rotates, a crown wheel 20 and a ratchet wheel 21 rotate in this order, and a mainspring (a power source) (not illustrated) housed in a movement barrel complete 22 is wound up. The movement barrel complete 22 is pivotally supported between the main plate 11 and a barrel bridge 23.

A center wheel and pinion 25, a third wheel and pinion 26, a second wheel and pinion 27, and an escape wheel and pinion 35 are pivotally supported between the main plate 11 and a train wheel bridge 24. When the movement barrel complete 22 rotates due to a restoring force of the mainspring, the center wheel and pinion 25, the third wheel and pinion 26, and the second wheel and pinion 27 rotate in order. The movement barrel complete 22, the center wheel and pinion 25, the third wheel and pinion 26, and the second wheel and pinion 27 form a front train wheel.

When the center wheel and pinion 25 rotates, a cannon pinion (not illustrated) rotates based on the rotation, and the minute hand 6 illustrated in FIG. 1 that is attached to the cannon pinion displays the “minutes”. When the cannon pinion rotates, an hour wheel (not illustrated) rotates via a minute wheel (not illustrated), and the hour hand 5 illustrated in FIG. 1 that is attached to the hour wheel displays the “hours”. When the second wheel and pinion 27 rotates, the second hand 7 illustrated in FIG. 1 that is attached to the second wheel and pinion 27 displays the “seconds”.

An escapement and speed control mechanism 30 for controlling the rotation of the front train wheel is disposed on a front side of the movement 10.

The escapement and speed control mechanism 30 includes the escape wheel and pinion 35 that meshes with the second wheel and pinion 27, a pallet fork 36 that causes the escape wheel and pinion 35 to escape and rotate regularly, and a balance with hairspring 40. Hereinafter, the structure of the balance with hairspring 40 will be described.

(Configuration of Balance with Hairspring)

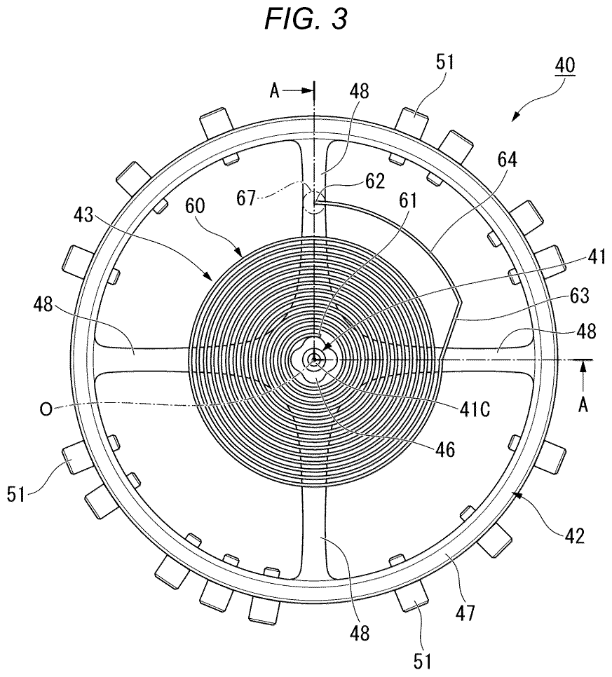

As illustrated in FIG. 3, the balance with hairspring 40 includes a balance staff 41, a balance wheel 42, and a hairspring 43, and reciprocally rotates (rotates forward and backward) around a central axis O of the balance staff 41 at a constant oscillation cycle (an oscillation angle) by using power of the hairspring 43.

In the present embodiment, a direction orthogonal to the central axis O of the balance staff 41 can be referred to as a radial direction, and a direction going around the central axis O in plan view seen from the central axis O direction can be referred to as a circumferential direction.

The balance staff 41 is formed of, for example, high-carbon steel, and is a rod-shaped member extending along the central axis O. A tapered first tenon 41C and a tapered second tenon 41D are formed at both ends of the balance staff 41 in the axial direction.

The balance staff 41 is pivotally supported between the main plate 11 and the balance bridge (not illustrated) via the first tenon 41C and the second tenon 41D. A substantially central portion of the balance staff 41 in the axial direction is fixed in a fitting hole 50 to be described later of the balance wheel 42 by, for example, press-fitting. Accordingly, the balance staff 41 and the balance wheel 42 are integrally fixed.

An annular double roller 44 is externally fitted coaxially with the central axis O onto the balance staff 41 at a portion located closer to the second tenon 41D than the balance wheel 42. The double roller 44 includes a flange portion 44a protruding outward in the radial direction. An impulse pin 45 for swinging the pallet fork 36 is fixed to the flange portion 44a.

Further, an annular collet 46 for fixing the hairspring 43 is externally fitted coaxially with the central axis O onto the balance staff 41 at a portion located closer to the first tenon 41C than the balance wheel 42.

The balance wheel 42 is disposed coaxially with the central axis O and includes an annular rim portion 47 that surrounds the balance staff 41 from the outside in the radial direction, and an arm portion 48 that connects the rim portion 47 and the balance staff 41 in the radial direction.

The rim portion 47 is formed of a metal such as brass. A plurality of arm portions 48 extend in the radial direction and are disposed at intervals in the circumferential direction. In the illustrated example, four arm portions 48 are disposed at intervals of 90 degrees around the central axis O. However, the number, the disposition, and the shape of arm portions 48 are not limited to this case.

Outer end portions of the arm portions 48 in the radial direction are integrally coupled to an inner peripheral portion of the rim portion 47, and inner end portions thereof in the radial direction are connected to each other to be integrated. The fitting hole 50 disposed coaxially with the central axis O is formed in a coupling portion 49 where the inner end portions of arm portions 48 are integrated. As described above, the balance staff 41 is fixed in the fitting hole 50 by, for example, press-fitting.

Further, an adjustment screw (an adjustment portion) 51 for adjusting a mass balance around the central axis O of the entire balance with hairspring 40 including the hairspring 43 and the balance wheel 42 is attached to the rim portion 47.

A plurality of adjustment screws 51 are disposed at intervals in the circumferential direction and are screwed to the rim portion 47 from the outside in the radial direction, for example. By performing adjustments such as removing one or more adjustment screws 51, the mass balance around the central axis O can be adjusted, and a so-called one-sided weight (mass imbalance) can be reduced.

When adjusting the mass balance, the adjustment can generally be done by cutting the rim portion 47 itself, but a configuration in which adjustment is performed using the adjustment screw 51 described above is also acceptable.

### (Configuration of Hairspring)

The hairspring 43 includes a hairspring body 60 whose inner end portion 61 is fixed to the balance staff 41 via the collet 46.

The hairspring body 60 is a thin leaf spring made of metal, silicon, or the like, and is formed in a spiral shape when viewed from the axial direction of the balance staff 41.

Specifically, the hairspring body 60 is formed in a spiral shape along an Archimedes curve in a polar coordinate system with the central axis O as an origin.

Accordingly, the hairspring body 60 is wound with a plurality of turns such that turns are adjacent to each other at approximately equal intervals in the radial direction when viewed from the axial direction of the balance staff 41.

In the illustrated example, the hairspring body 60 is formed with 14 turns by advancing unwinding along the Archimedes curve with a connection portion between the inner end portion 61 and the collet 46 as an unwinding position, but the illustrated example is one example, and an appropriate number of turns is selected by the movement.

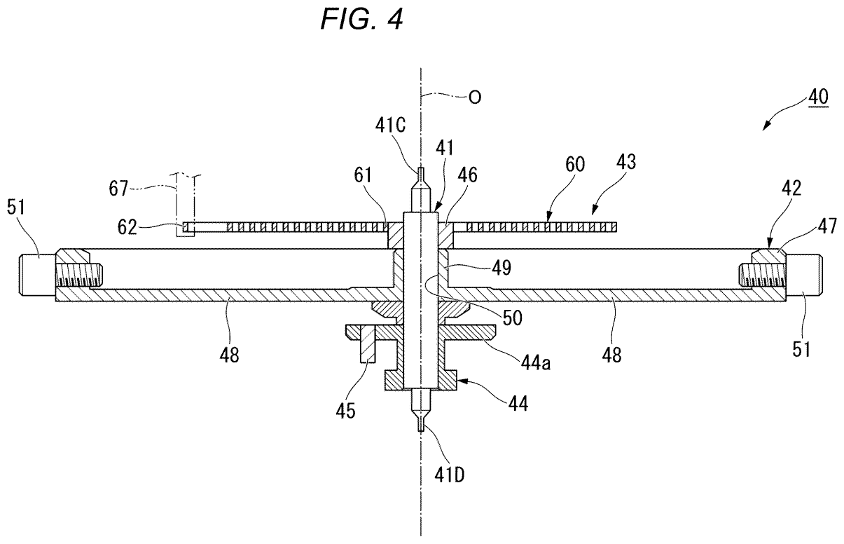

A part of an outermost peripheral portion (a fourteenth winding) of the hairspring body 60 is separated outward in the radial direction via a reformed portion 63 and is formed as an arc portion 64 with a radius of curvature larger than that of other portions. An end portion of the arc portion 64 is an outer end portion 62 of the hairspring body 60 and is fixed to a stud 67 attached via a stud support (not illustrated). In FIGS. 3 and 4, the stud 67 is indicated by a two-dot chain line. A regulator 68 that adjusts the moving distance of the hairspring body 60 is provided adjacent to the stud 67.

In the timepiece 1, a plurality of part fixation screws 69 are provided for fixing parts such as the barrel bridge 23 and the train wheel bridge 24 or other parts to the main plate 11 or other parts.

The configuration including the movement 10 of the timepiece 1 has been described above, but in the timepiece 1, the center wheel and pinion 25 includes a center pinion 25A and a center wheel 25B, the third wheel and pinion 26 includes a third pinion 26A and a third wheel 26B, and the second wheel and pinion 27 includes a second pinion 27A and a second wheel 27B.

The escape wheel and pinion 35 includes an escape pinion 35A and an escape wheel 35B, and the pallet fork 36 includes a pallet staff 36A and a body of pallet fork 37.

In the timepiece 1 described above, one or two or more of the center pinion 25A, the center wheel 25B, the third pinion 26A, the third wheel 26B, the second pinion 27A, the second wheel 27B, the escape pinion 35A, the escape wheel 35B, the pallet staff 36A, the body of pallet fork 37, the balance staff 41, the balance wheel 42, the collet 46, the double roller 44, the regulator (including a regulator pointer) 68, and the part fixation screw 69 are made of a Ni—Cr—Al alloy described below.

Although not illustrated, in addition to the above-described timepiece move part, any one or two or more of a center second pinion, a center second wheel, an intermediate escape pinion, an intermediate escape wheel, and a fine adjustment lever are made of a precipitation-hardened Ni—Cr—Al alloy described below.

The Ni—Cr—Al alloy applied to the present embodiment has a composition of 30 mass % to 40 mass % of Cr, 3 mass % to 5 mass % of Al, and the balance being Ni and unavoidable impurities. The Ni—Cr—Al alloy is a Ni—Cr—Al alloy including an αCr phase, a γ phase which is a solid solution of NiCr, and a γ′ phase containing Ni₃Al. It is preferable that the Ni—Cr—Al alloy has a crystallite size of 152 Å to 213 Å, calculated from a 400-diffraction peak obtained by X-ray diffraction for the γ phase and the γ′ phase. Further, the crystallite size is more preferably 152 Å to 198 Å, and the crystallite size is most preferably 152 Å to 193 Å.

The Ni—Cr—Al alloy further contains 0.8 mass % or less of one or more elements selected from B, Mg, Ti, and Si.

Adding a trace amount of B to the Ni—Cr—Al alloy improves the workability during hot forging. However, when the B content exceeds an appropriate amount, a compound is formed with other metal elements, and when the B content is too small, the effect is poor. A more preferred range of the B content is about 20 ppm to 150 ppm.

Similar to the addition of B, Mg is effective in improving hot workability. Mg may be added as a deoxidizing agent in the production process of the alloy.

Ti is added as a deoxidizing agent and contributes to formation of the γ′ phase as Ni₃(Al, Ti) when added in a trace amount. When the content is too large, a different phase may be precipitated, and therefore, it is desirable that the content is within the above-described range.

Si is added as a deoxidizing agent in the production process of the alloy and may remain in a trace amount in the alloy. The addition of Si contributes to improvement of abrasion resistance.

Mn is added as a desulfurizing agent and a deoxidizing agent in the production process of the alloy and may remain in a trace amount in the alloy.

An alloy that exhibits a three-phase precipitation state of the αCr phase, the γ phase, and the γ′ phase at room temperature is a γ′ (Ni₃Al) precipitation-hardened Ni—Cr—Al alloy. The Ni—Cr—Al alloy is an alloy having high hardness and excellent corrosion resistance. The Ni—Cr—Al alloy is a paramagnetic material and has a low magnetic permeability.

A relative magnetic permeability of the Ni—Cr—Al alloy is, for example, less than 1.01.

The hardness of the Ni—Cr—Al alloy is preferably 650 HV or more, for example, 700 HV±50 HV.

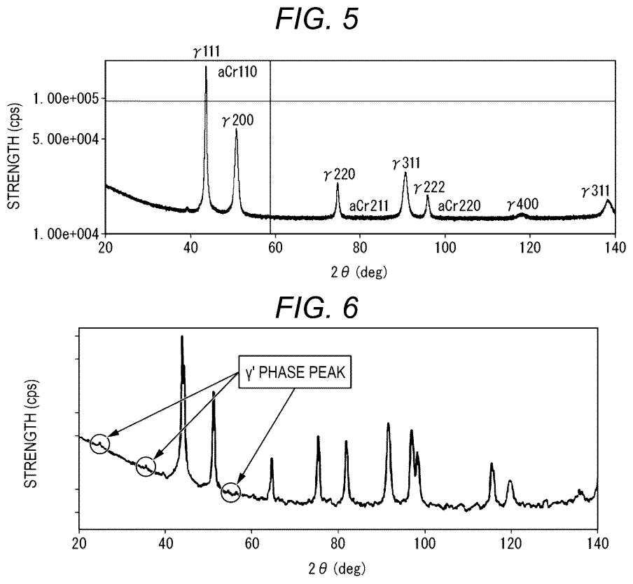

For example, FIG. 5 illustrates an X-ray diffraction pattern of a Ni—Cr—Al alloy containing Ni-38 mass % Cr-4 mass % Al as a main component, when the Ni—Cr—Al alloy is solution-treated (quenched) in a two-phase state temperature range of the γ phase and the αCr phase.

As illustrated in FIG. 5, it can be seen that since a plurality of diffraction peaks indicating the presence of the γ phase and a plurality of diffraction peaks indicating the presence of the αCr phase are obtained, the alloy exhibits a two-phase structure of the γ phase and the αCr phase.

FIG. 6 illustrates an X-ray diffraction pattern after the alloy is processed into a predetermined shape by cutting or forging and then subjected to an aging treatment at 590° C. for 24 hours.

As illustrated in FIG. 6, it can be seen that after the aging treatment, the Ni—Cr—Al alloy exhibits a three-phase structure including a γ phase (Cu type: FCC), a γ′ phase (Cu₃Au type: L12), and an αCr phase (W type: BCC). In FIG. 6, diffraction peaks of the γ phase, in accordance with the extinction rules, were observed at 2θ=24.9°→100, 35.5°→110, and 57.65°→210 with CuKα indicate the presence of the γ′ phase.

In the Ni—Cr—Al alloy, the γ′ phase precipitates coherently with the γ phase, and a decrease in toughness due to hardening (increased hardness) can be prevented. The presence of a γ-γ′ coexistence portion where the γ′ phase precipitates coherently with the γ phase can be confirmed by taking a selected area density (SAD) image using a transmission electron microscope (TEM). By the aging treatment, the Ni₃Al phase precipitates coherently (in conformity) with the γ phase, which is a matrix phase, and therefore, unlike precipitation hardening due to a different phase, a decrease in toughness due to an increase in hardness can be prevented.

The Ni—Cr—Al alloy having the above-described composition and having the above-described three-phase structure exhibits characteristics equal to or higher than those of a carbon steel part applied to a move part of a timepiece in the related art. The high-carbon steel applied to the timepiece move part requires two heat treatments including quenching and tempering, but in the case of the Ni—Cr—Al alloy, desired hardness for the timepiece move part can be obtained by one heat treatment of only aging. The Ni—Cr—Al alloy has characteristics that a variation in hardness after the aging treatment is small and a heat treatment temperature is low. Therefore, in the case of the Ni—Cr—Al alloy, the manufacturing process can be simplified as compared with the case of using the high-carbon steel.

In the case of the Ni—Cr—Al alloy, regarding the aging treatment, an aging time is slowed down in the heat treatment at a constant temperature, and a decrease in hardness after overaging is gradual. Therefore, the Ni—Cr—Al alloy has a characteristic that the mass productivity is excellent. This is because the Ni—Cr—Al alloy follows the t^{(1/3)} law controlled by volume diffusion. Therefore, a decrease in hardness due to overaging after reaching the maximum hardness is small. Therefore, the variation in hardness can be prevented in a mass production process.

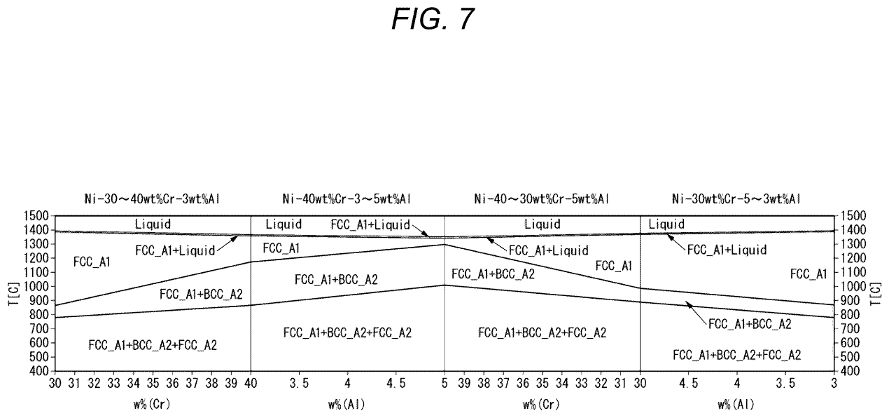

FIG. 7 is a state diagram in which a range of Ni-30 mass % to 40 mass % Cr-3 mass % Al, a range of Ni-40 mass % Cr-3 mass % to 5 mass % Al, a range of Ni-40 mass % to 30 mass % Cr-5 mass % Al, and a range of Ni-30 mass % Cr-5 mass % to 3 mass % Al are extracted from an Al—Cr—Ni ternary triangular composition diagram. FIG. 7 illustrates FCC_A1: γ (Ni-based solid solution), BCC_A2: αCr (αCr phase), and FCC_A2: γ′ (Ni₃Al phase superlattice).

As described above, the Ni—Cr—Al alloy used in the present invention has a central composition of Ni-38 mass % Cr-4 mass % Al, and based on the state diagram calculation result illustrated in FIG. 7, it is considered that in a composition range of approximately 30 mass % to 40 mass % of Cr and 3 mass % to 5 mass % of Al, when the aging temperature and the treatment time are appropriately selected, a metal structure and hardness similar to those of the central composition can be reproduced.

As is clear from the state diagram in FIG. 7, in the case of the Ni—Cr—Al alloy having the above composition, the temperature range where the αCr phase and the γ phase coexist can be ensured to be at least nearly 100° C., and therefore, the solution treatment can be performed while preventing the growth of γ crystal grains, and therefore intermediate annealing can be performed stably in the mass production process.

Since the aging temperature of the Ni—Cr—Al alloy having the above composition range can be set to 780° C. or lower in the entire composition range, a rapid decrease in hardness due to the overaging can be prevented.

Further, the Ni—Cr—Al alloy also has excellent corrosion resistance. A pitting resistance equivalent number (PREN), which indicates corrosion resistance, of SUS316L, a material generally known to have high corrosion resistance, is 26, whereas the γ′ (Ni₃Al) precipitation-hardened Ni—Cr—Al alloy has a pitting resistance equivalent number (PREN) of 30 even when the Cr content is at the minimum within the composition range, and therefore has excellent corrosion resistance.

Impact absorption energy of the Ni—Cr—Al alloy is preferably 2.1 J/cm² or more. The Ni—Cr—Al alloy having the above-described three-phase structure has impact absorption energy larger than that of the quenched and tempered high-carbon steel. This means that a timepiece resistant to a drop impact can be provided as a timepiece move part.

Tensile strength of the Ni—Cr—Al alloy is preferably 1980 MPa or more.

The timepiece move part made of the Ni—Cr—Al alloy preferably includes a surface-hardened layer in a range (a surface layer portion) from an outermost surface to a depth of 15 μm.

When the timepiece move part is formed of the Ni—Cr—Al alloy having the three-phase structure, the timepiece move part is less likely to be magnetized by an external magnetic field, and thus no stop or no rate shift occurs and a timepiece move part that does not adversely affect the accuracy of the timepiece can be provided. Since the timepiece move part has excellent abrasion resistance and impact resistance, a timepiece having excellent durability can be provided.

In the case of the Ni—Cr—Al alloy, since the variation in hardness during the aging treatment is small, a timepiece move part excellent in manufacturability during mass production can be provided.

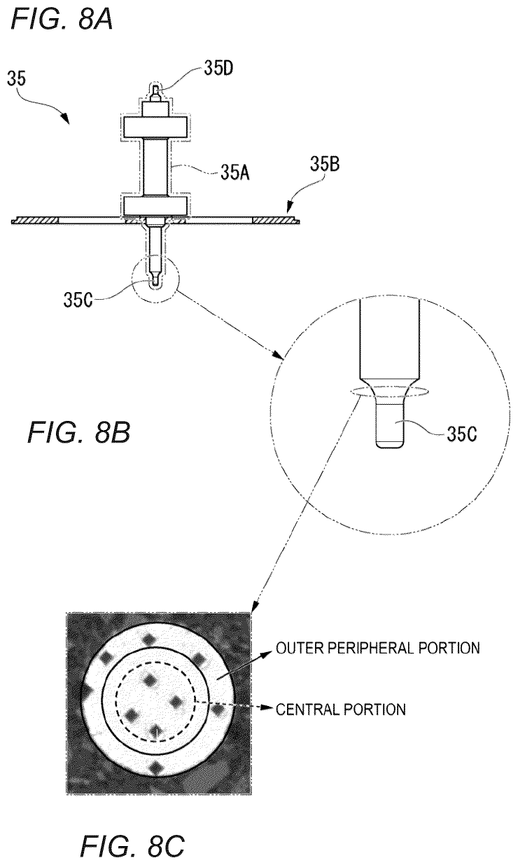

FIGS. 8(A)-8(C) illustrates the escape wheel and pinion 35, and the escape wheel and pinion 35 includes the shaft-type escape pinion 35A and the escape wheel 35B.

The escape pinion 35A is made of the Ni—Cr—Al alloy having the three-phase structure described above. A first tenon 35C is formed at one end of the escape pinion 35A, and a second tenon 35D is formed at the other end of the escape pinion 35A. The first tenon 35C and the second tenon 35D are a shaft end portion having a small diameter.

The first tenon 35C and the second tenon 35D are preferably subjected to a burnishing treatment. The burnishing treatment is a process of smoothing a surface of metal and is a process of pressing and leveling surfaces of the first tenon 35C and the second tenon 35D using a tool such as a rotating metal roller.

By performing the burnishing, hardened layers are formed in surface layer portions of the first tenon 35C and the second tenon 35D, and the surface hardness can be improved. The first tenon 35C and the second tenon 35D are formed to have an outer diameter of about 90 μm.

Even such a timepiece move part having a small outer diameter can be provided as a timepiece move part having excellent impact resistance as long as the timepiece move part is made of the Ni—Cr—Al alloy having the three-phase structure described above and includes a hardened layer accompanying burnishing as a surface layer portion.

For example, when hardness of the first tenon 35C and the second tenon 35D on an axial center side is 722 HV, hardness of outer circumferential surfaces of the first tenon 35C and the second tenon 35D after the burnishing can be improved to about 742 HV.

With this structure, more excellent impact resistance can be obtained while maintaining the same level of abrasion resistance as that of the high-carbon steel (PbS100C) in the related art. Since the first tenon 35C and the second tenon 35D are particularly thin portions, it is important to have excellent impact resistance and abrasion resistance. In this regard, the presence of the hardened layer in the surface layer portions of the first tenon 35C and the second tenon 35D contributes to improvement in impact resistance and abrasion resistance.

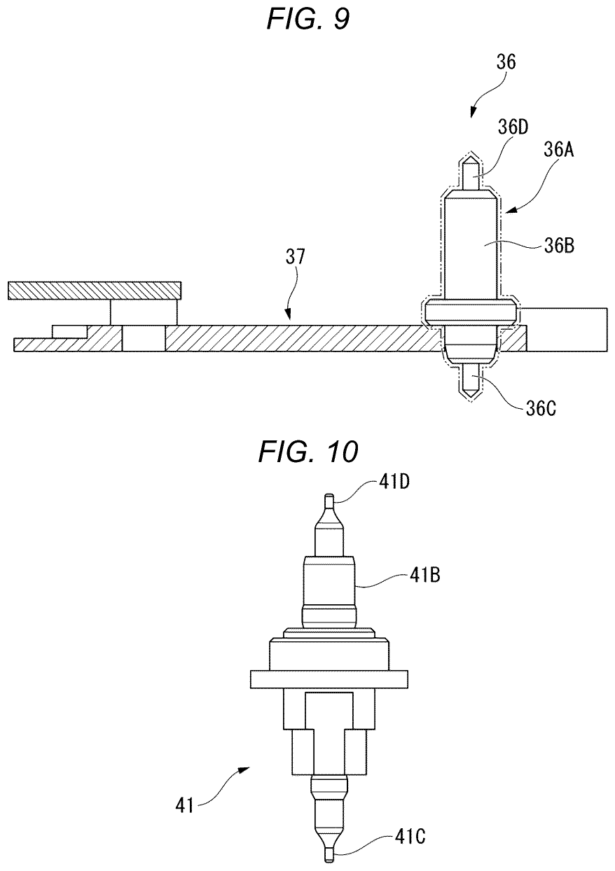

In addition to the escape pinion 35A desirably formed of the Ni—Cr—Al alloy having the three-phase structure described above, the pallet staff 36A having a shape represented by a shape illustrated in FIG. 9 and the balance staff 41 having a shape represented by a shape illustrated in FIG. 10 can be exemplified as shaft members desirably applied.

The pallet staff 36A in FIG. 9 includes a first tenon 36C and a second tenon 36D and is therefore burnished to form a surface-hardened layer, providing an effective structure for obtaining excellent abrasion resistance and high impact resistance.

The balance staff 41 in FIG. 10 includes the first tenon 41C and the second tenon 41D and is therefore burnished to form a surface-hardened layer, providing an effective structure for obtaining excellent abrasion resistance and high impact resistance.

Therefore, when the Ni—Cr—Al alloy having the three-phase structure described above is applied to the timepiece move part and the surface-hardened layer is introduced by burnishing, a timepiece move part having excellent abrasion resistance and high impact resistance can be provided.

### EXAMPLE

A Ni—Cr—Al alloy containing Ni-38 mass % Cr-4 mass % Al as a main component was solution-treated (quenched) in a two-phase state temperature range of a γ phase and an αCr phase, and then aged to obtain a Ni—Cr—Al alloy exhibiting a three-phase structure of a γ phase (Cu type: FCC), a γ′ phase (Cu₃Au type: L12), and an αCr (W type: BCC). A specific gravity of the Ni—Cr—Al alloy is 7.6 and a specific gravity of high-carbon steel (PbS100C) generally applied to a shaft member of a timepiece part is 7.82, and thus the two materials have substantially the same specific gravity.

The Ni—Cr—Al alloy after the solution treatment has an X-ray diffraction pattern illustrated in FIG. 5, which indicates that the Ni—Cr—Al alloy is in a two-phase state including the γ phase and the αCr phase. An X-ray diffraction pattern of the alloy after aging treatment at 590° C. for 24 hours is an X-ray diffraction pattern illustrated in FIG. 6 described above. It can be seen from FIG. 6 that the alloy after the aging treatment is a Ni—Cr—Al alloy exhibiting a three-phase structure of a γ phase (Cu type: FCC), a γ′ phase (Cu₃Au type: L12), and an αCr (W type: BCC).

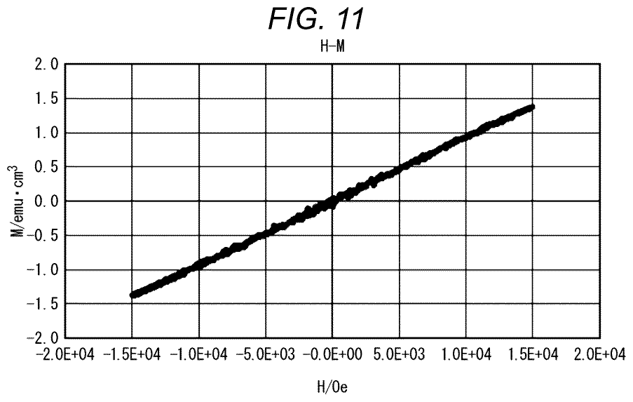

FIG. 11 illustrates a result of performing a vibrating sample magnetometer (VSM) measurement at room temperature on the Ni—Cr—Al alloy after the aging treatment described above.

Measurement conditions are φ 2.0×h 2 mm, diamagnetic field coefficient Nd=0.27, W=0.04733, and
g, ρ=7.532 g/cm³ (large material measurement: 7.6034 g/cm³).

As a result of the VSM measurement, it can be seen that a relative magnetic permeability of the Ni—Cr—Al alloy after the aging treatment was 1.001, no hysteresis was observed, and the alloy was not a ferromagnetic material. The relative magnetic permeability was less than 1.01, which was sufficiently low magnetic permeability.

Next, for the Ni—Cr—Al alloy having the above-described composition after the solution treatment, a relationship between hardness and a crystallite size after the aging treatment depending on an aging temperature and an aging time was determined. The crystallite size is a value calculated from a 400-diffraction peak to be described later.

Specifically, the aging treatment temperature was set to any temperature of 521° C., 554° C., 590° C., 629° C., 672° C., and 718° C. The aging treatment time was set to any of 2 hours, 4 hours, 8 hours, 12 hours, 16 hours, 20 hours, 24 hours, 48 hours, 60 hours, 72 hours, 96 hours, 120 hours, 168 hours, 192 hours, 240 hours, and 442 hours, and the aging treatment was performed.

Center hardness (HV1) of the Ni—Cr—Al alloy obtained by any combination of the aging temperature and the aging time was measured. The results are shown in Table 1 below.

With respect to the Ni—Cr—Al alloy produced at the aging temperature and the aging time adopted in Table 1, a value of the crystallite size calculated by an FP method described below was obtained from the 400-diffraction peak diffracted from the γ′ phase and the γ phase. In calculating the crystallite size, the background was removed.

In the calculation of the crystallite size, a fundamental parameter method (an FP method) was applied, which can calculate the crystallite size by calculating and correcting peak width broadening caused by the device.

The measurement conditions are as follows. An emission profile of CuKαradiation is reproduced by adding five Lorentzian functions from five radiations (Kα1, Kα2, and three satellite peaks). Measurement was performed using a parallel beam and a PB-Slit optical system using a Soller slit, and correction was performed using a device function. For axial divergence, a model of T. Ida was selected. A crystallite size distribution was approximated by a log-normal distribution. The crystallite size is an average crystallite size (an average number of crystallites).

### “Definition of 400 Diffraction Peaks”

The prior γ400 diffraction peak at the beginning of aging may be separated into a γ phase peak with a low Cr concentration and a γ′ phase of Ni₃Al and a γ phase containing Cr in a solid solution in equilibrium, resulting in the presence of two 400 diffraction peaks. In the present invention, the 400-diffraction peak that appears after aging treatment is used to calculate the crystallite size, rather than the 400-diffraction peak of the prior γ phase observed in the solution-treated material (before the aging treatment).

The calculation results of the crystallite size are shown in Table 1 below together with the hardness.

TABLE 1

| Aging | | | | | | | | | | | | | | | | | |
|---|---|---|---|---|---|---|---|---|---|---|---|---|---|---|---|---|---|
| temper- | Measure- | Aging time [h] | | | | | | | | | | | | | | | |
| ature | ment item | 2 | 4 | 8 | 12 | 16 | 20 | 24 | 48 | 60 | 72 | 96 | 120 | 168 | 192 | 240 | 442 |
| 521° C. | Hardness | | | | 428 | 605 | 670 | 724 | 727 | | | 737 | | | | 730 | |
| | [HV1] | | | | | | | | | | | | | | | | |
| | Crystallite | | | | 149 | 150 | 158 | 158 | 162 | | | 160 | | | | 178 | |
| | size [Å] | | | | | | | | | | | | | | | | |
| 554° C. | Hardness | | 555 | 715 | 716 | | | 727 | | 747 | | | | 700 | | 700 | |
| | [HV1] | | | | | | | | | | | | | | | | |
| | Crystallite | | 151 | 162 | 159 | | | 164 | | 170 | | | | 180 | | 193 | |
| | size [Å] | | | | | | | | | | | | | | | | |
| 590° C. | Hardness | | 655 | 727 | 744 | 749 | 744 | 731 | 718 | | | 694 | | | 662 | | 650 |
| | [HV1] | | | | | | | | | | | | | | | | |
| | Crystallite | | 168 | 155 | 152 | 172 | 182 | 171 | 184 | | | 195 | | | 206 | | 210 |
| | size [Å] | | | | | | | | | | | | | | | | |
| 629° C. | Hardness | 694 | 698 | 720 | 719 | 712 | | 686 | | | | 653 | 650 | | | | |
| | [HV1] | | | | | | | | | | | | | | | | |
| | Crystallite | 177 | 180 | 165 | 176 | 198 | | 193 | | | | 213 | 212 | | | | |
| | size [Å] | | | | | | | | | | | | | | | | |
| 672° C. | Hardness | 726 | 710 | 696 | | 651 | | 648 | 615 | | 594 | | | | | | |
| | [HV1] | | | | | | | | | | | | | | | | |
| | Crystallite | 172 | 177 | 186 | | 197 | | 209 | 218 | | 225 | | | | | | |
| | size [Å] | | | | | | | | | | | | | | | | |
| 718° C. | Hardness | 643 | | | | 592 | | | | 531 | | | | | 501 | | |
| | [HV1] | | | | | | | | | | | | | | | | |
| | Crystallite | 186 | | | | 195 | | | | 220 | | | | | 240 | | |
| | size [Å] | | | | | | | | | | | | | | | | |

From the results illustrated in Table 1, it could be seen that when the aging treatment was performed at the same temperature, a decrease in hardness due to overaging is small even when the aging time is several to several tens of times longer than the aging time required to obtain hardness equivalent to or exceeding that of high-carbon steel (PbS100C) in related art (standard 650 HV to 750 HV). This can be presumed to be because the Ni—Cr—Al alloy follows the t^{(1/3)} law controlled by volume diffusion. Accordingly, it is considered that the decrease in hardness during the overaging is gradual, and the timepiece move part that is less affected by aging conditions and is excellent in mass productivity can be obtained.

The hardness standard of the high-carbon steel (PbS100C) applied to the timepiece part is HV700±50 (650 HV to 750 HV).

As can be interpreted from the results illustrated in Table 1, in the Ni—Cr—Al alloy after the aging treatment, when an appropriate aging time is adopted in the range of 521° C. to 672° C., the hardness of 650 HV1 to 750 HV1 can be obtained. Therefore, when an appropriate aging treatment is performed by applying the Ni—Cr—Al alloy, a timepiece move part having hardness equivalent to that of the high-carbon steel (PbS100C) as a current material can be obtained.

While the high-carbon steel as the current material requires management of two heat treatments including quenching and tempering, the Ni—Cr—Al alloy only requires management of the aging treatment, which contributes to simplifying the manufacturing process.

With regard to the magnitude of the crystallite size, it is presumed that there is a tendency of a decrease in hardness as in the case of a general metal material with an increase in crystal grains.

From the relationship between the calculation result of the crystallite size illustrated in Table 1 and the hardness illustrated in Table 1, it is considered that the crystallite size is preferably set to 152 Å to 213 Å, and more preferably set to 152 Å to 198 Å in order to obtain desirable hardness of 650 HV to 750 HV for a timepiece move part. For example, it was found that the hardness of 650 HV or more was easily obtained by setting the crystallite size to 152 Å to 213 Å, and the hardness of 700 HV or more was easily obtained by setting the crystallite size to 152 Å to 198 Å. It is considered that the most preferable range for the crystallite size is 172 Å to 193 Å. For example, when the crystallite size was 172 Å to 193 Å, high hardness of about 750 HV was easily obtained.

Next, regarding the Ni—Cr—Al alloy sample subjected to the aging treatment under any of conditions of 521° C. for 12 hours, 554° C. for 4 hours or 240 hours, 590° C. for 4 hours, 8 hours, 16 hours, 24 hours, 629° C. for 96 hours, and 718° C. for 192 hours, the measurement results of the hardness (HV), the crystallite size (Å), and the impact absorption energy (J/cm²) are summarized in the following Table 2.

TABLE 2

| Heat treatment | Hardness | Crystallite size | Impact absorption energy |
|---|---|---|---|
| condition | [HV] | [Å] | [J/cm²] |
| 718° C. × 192 h | 501 | 240 | 27.11 |
| 629° C. × 96 h | 653 | 213 | 5.85 |
| 554° C. × 240 h | 700 | 193 | 3.47 |
| 554° C. × 4 h | 555 | 151 | 2.79 |
| 521° C. × 12 h | 428 | 149 | 2.13 |
| 590° C. × 4 h | 655 | 168 | 2.70 |
| 590° C. × 8 h | 727 | 155 | 2.45 |
| 590° C. × 16 h | 749 | 172 | 2.46 |
| 590° C. × 24 h | 731 | 171 | 2.46 |

From the results illustrated in Table 2, it is considered that the impact absorption energy tends to increase as the crystallite size increases, but the hardness tends to decrease as illustrated in Table 1. Therefore, for the Ni—Cr—Al alloy subjected to aging treatment, from the results illustrated in Tables 1 and 2, it is considered that it is preferable to set the crystallite size in the above-described range.

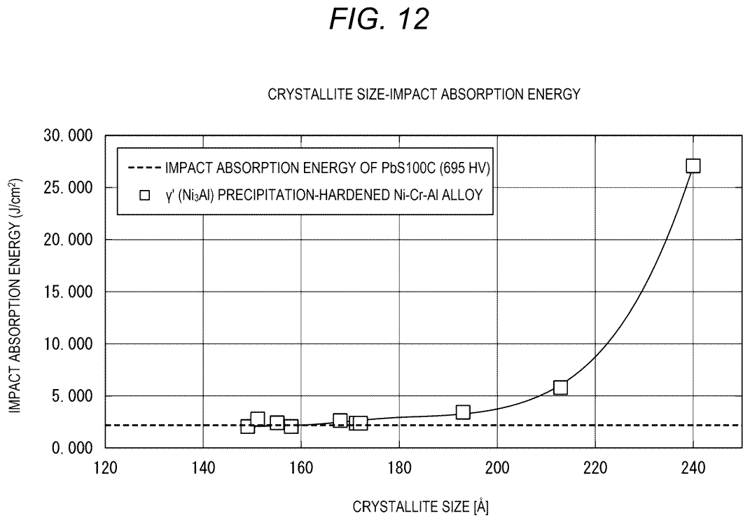

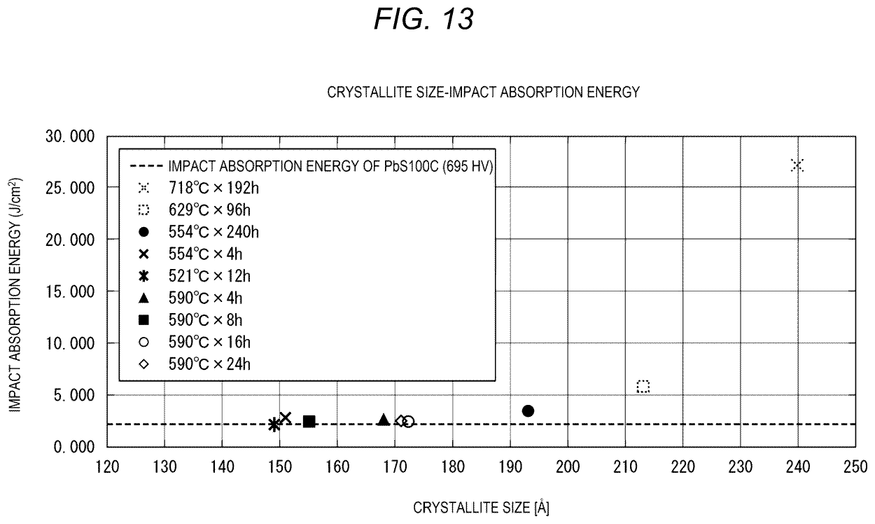

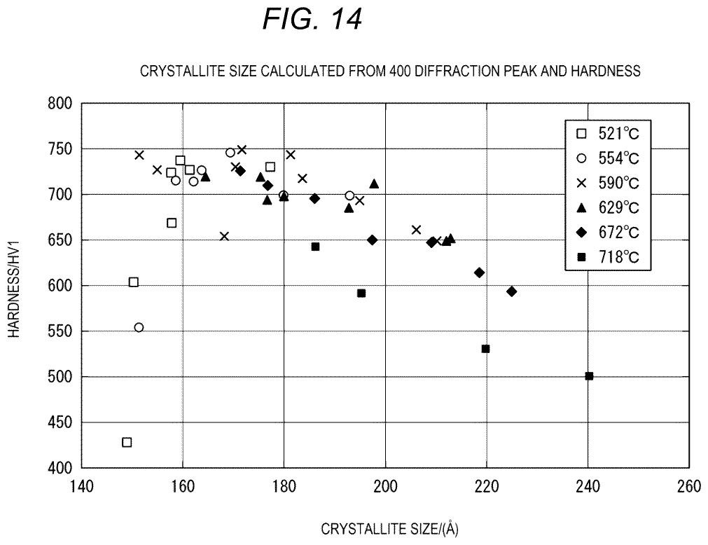

FIGS. 12 and 13 are graphs illustrating a relationship between the value of the crystallite size and the impact absorption energy for the Ni—Cr—Al alloy. FIG. 13 is a graph illustrating the relationship between the crystallite size and the impact absorption energy of each sample under the heat treatment conditions illustrated in Table 2. FIG. 14 is a graph illustrating the relationship between the crystallite size and the hardness calculated from the 400-diffraction peak by the FP method.

As is clear from the comparison illustrated in FIG. 12 and FIG. 13, it can be seen that when the timepiece move part is formed by using the Ni—Cr—Al alloy after the aging treatment, the impact absorption energy higher than that of the timepiece move part made of the high-carbon steel (PbS100C) as the current material can be obtained.

It can be seen from the relationship between the crystallite size and the impact absorption energy illustrated in FIGS. 12 and 13 and the relationship between the crystallite size and the hardness illustrated in FIG. 14 that the range of the desirable crystallite size of 152 Å to 213 Å determined from the numerical values illustrated in Tables 1 and 2 is appropriate. For example, it can be seen that all samples having a crystallite size of less than 152 Å have low hardness, and samples having a crystallite size of more than 213 Å also have low hardness.

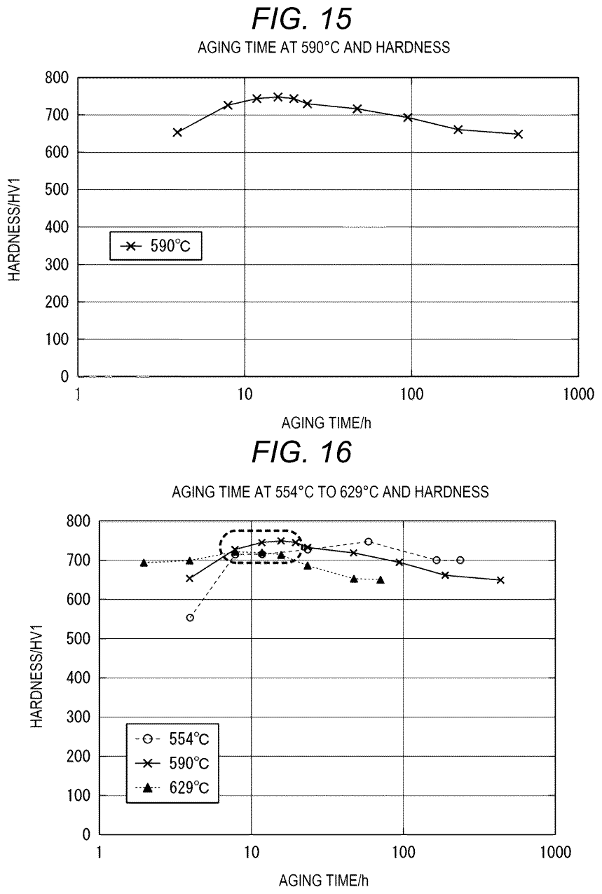

FIG. 15 is a graph illustrating a relationship between the aging time (h) and the hardness (HV1) for the Ni—Cr—Al alloy sample subjected to the aging treatment under the conditions of the aging temperature of 590° C. and the aging time of 2 hours to 240 hours illustrated in Table 1.

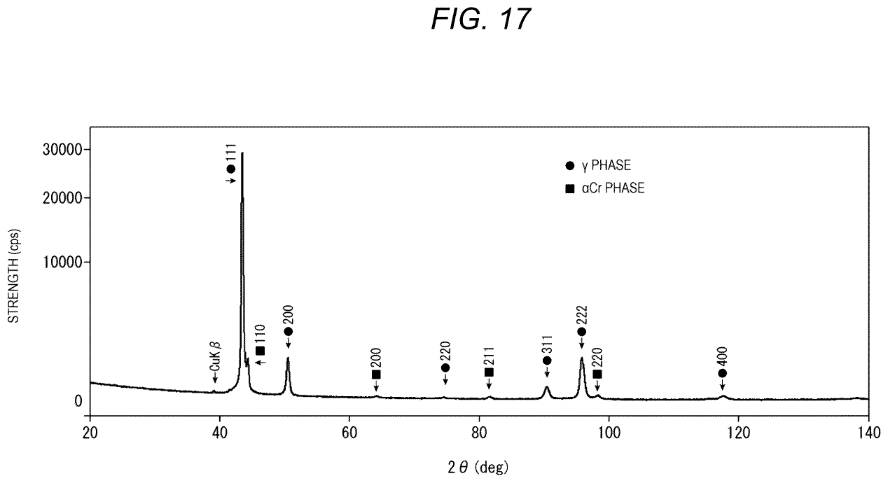

FIG. 16 is a graph illustrating a relationship between the aging time (h) and the hardness (HV1) for the Ni—Cr—Al alloy subjected to the aging treatment under the conditions of the aging temperature of 554° C., 590° C., 629° C., and the aging time of 2 hours to 442 hours illustrated in Table 1.

From the results illustrated in FIG. 15 and FIG. 16, it can be seen that the decrease in hardness during the overaging, as previously inferred from the results illustrated in Table 1, is gradual, and a timepiece move part that is less affected by aging conditions and is excellent in mass productivity can be provided. For example, it can be seen that even when the temperature is varied within a range of −30° C. to +40° C., with the aging temperature at 590° C. as the center, the timepiece move part with sufficiently high hardness can be stably produced.

An escape wheel and an escape pinion having a shape illustrated in FIGS. 8(A)-8(C) were produced using the Ni—Cr—Al alloy containing Ni-38 mass % Cr-4 mass % Al as a main part, and outer peripheral portions of the first tenon 35C and the second tenon 35D were subjected to a burnishing treatment. The first tenon 35C and the second tenon 35D have an outer diameter of 90 μm. The burnishing treatment is a treatment of pressing and leveling surfaces of shaft portions such as the first tenon 35C and the second tenon 35D using a tool such as a rotating metal roller.

A cut model of the produced first tenon 35C (a position surrounded by an elliptical two-dot chain line illustrated in FIG. 8(B)) was taken, and hardness measurement was performed using a micro-Vickers hardness meter.

As illustrated in FIG. 8(C), when viewed from the shaft portion cross section of each tenon, the hardness was measured at an outer peripheral portion (five locations) closer to the center of 15 μm from an outer peripheral surface and a central portion (four locations) closer to the center of the shaft portion cross section.

In the shaft portion cross section, average hardness of the outer peripheral portion was 742 HV, and average hardness of the central portion was 722 HV. From this, it is considered that the hardness can be further increased even in the portions of the extremely thin first tenon and second tenon having an outer diameter of 90 μm. Thus, it is considered that the abrasion resistance of the timepiece move part can be improved.

The surface of the timepiece move part made of the Ni—Cr—Al alloy may be coated with noble metal plating such as Au, Pt, or Ru or an ion plating film such as diamond-like carbon (DLC).

The outer surfaces of the first tenon 35C and the second tenon 35D of the escape pinion 35A made of the Ni—Cr—Al alloy, the first tenon 36C and the second tenon 36D of the pallet staff 36A, and the first tenon 41C and the second tenon 41D of the balance staff 41 may be subjected to an oil repellent treatment in order to improve oil retention. When the oil repellent treatment is performed, the lubricating oil can be retained between the member subjected to the oil repellent treatment and the opposing member, and the abrasion resistance in the sliding portion between the tenon and the bearing (hole jewel) can be improved.

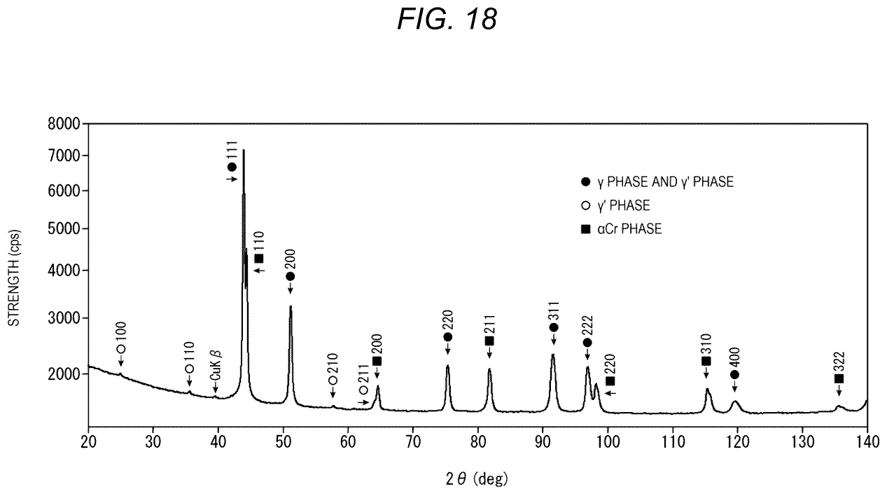

FIG. 17 illustrates an XRD spectrum (CuKα) of the Ni—Cr—Al alloy after the solution treatment, and FIG. 18 illustrates an XRD spectrum (CuKα) of the Ni—Cr—Al alloy after the aging treatment at 590° C. for 24 hours.

As illustrated in FIG. 18, the presence of the γ′ phase in addition to peaks of the γ phase and the αCr phase was confirmed in the samples subjected to the aging treatment.

What is claimed is:

1. A timepiece move part comprising:
a Ni—Cr—Al alloy containing 30 mass % to 40 mass % of Cr and 3 mass % to 5 mass % of Al, and including an αCr phase, a γ phase which is a solid solution of NiCr, and a γ′ phase containing Ni₃Al.

2. The timepiece move part according to claim 1, wherein
the Ni—Cr—Al alloy further contains 0.8 mass % or less of one or two or more elements selected from B, Mg, Ti, and Si.

3. The timepiece move part according to claim 1, wherein
the Ni—Cr—Al alloy has hardness of 650 HV or more.

4. The timepiece move part according to claim 1, wherein
the Ni—Cr—Al alloy has a crystallite size of 152 Å to 213 Å, calculated from a 400-diffraction peak obtained by X-ray diffraction for the γ phase and the γ′ phase.

5. The timepiece move part according to claim 1, wherein
the Ni—Cr—Al alloy has impact absorption energy of 2.1 J/cm² or more.

6. The timepiece move part according to claim 1, wherein
the Ni—Cr—Al alloy has tensile strength of 1980 MPa or more.

7. The timepiece move part according to claim 1, wherein
the timepiece move part includes a surface-hardened layer in a range from an outermost surface to a depth of 15 μm.

8. The timepiece move part according to claim 1, wherein
the Ni—Cr—Al alloy has a relative magnetic permeability of less than 1.01.

9. The timepiece move part according to claim 1, which is any one or two or more of a center pinion, a center wheel, a third pinion, a third wheel, a second pinion, a second wheel, a center second pinion, a center second wheel, an intermediate escape pinion, an intermediate escape wheel, an escape pinion, an escape wheel, a pallet staff, a body of pallet fork, a balance wheel, a balance staff, a collet, a double roller, a part fixation screw, a regulator, a regulator pointer, and a fine adjustment lever.

10. A timepiece comprising the timepiece move part according to claim 1.

11. A timepiece comprising the timepiece move part according to claim 9.
